(19) United States
(12) Patent Application Publication
(10) Pub. No.: US 2011/0030495 A1
(43) Pub. Date: Feb. 10, 2011

(54) Zero Turn Radius Riding Lawn Mower Forward and Reverse Steering Mechanism Dual Foot Pedal Control

(76) Inventor: Henry Clyde Sama, Gray, GA (US)

Correspondence Address: Henry C. Sama, 255 Wheeler Rd, Gray, GA, 31032, US

(21) Appl. No.: 12/461,207

(22) Filed: Aug. 4, 2009

(51) Int. Cl. G05G 13/00

(52) U.S. Cl. 74/484 R

(57) ABSTRACT

The nature of the technical disclosures of the invention is to introduce into the market something that is not available now, namely a dual pedal foot operated zero-turn radius riding lawn mower. The foot pedal operated model will have a distinct advantage in comfort for operators that must use their mowers for sustained periods of time such as cutting grass on large areas. The current market mower models are operated with hand and arm motions that are tedious and tiring to use and can aggravate certain health issues for some operators. In addition, by not requiring the hands for operation, safety is greatly increased by allowing operators to prevent low hanging tree limbs or branches from striking their body or head areas.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Due to severe arthritis in my hands, wrists, joints, and shoulders and because it was my responsibility to cut the grass on multiple plats of land with large acreage for my personal and the rental properties that I owned, I found it necessary to try to discover a way to use the riding mower without having to use my hands or arms as typically needed with the zero turn radius lawn mower.

### BRIEF SUMMARY OF THE INVENTION

The invention is intended to alleviate pain and discomfort of having to extend the hands and arms for long periods of time. It would be helpful for handicapped and non-handicapped operators of the equipment that suffer from arthritis, tendinitis or joint stiffness.

### BRIEF DESCRIPTION OF THE SEVERAL VIEWS OF THE DRAWING

Figures on drawing are shown as numeric-alpha:

FIG. 1A: Front of foot pedal

FIG. 1B: Rear of foot pedal

FIG. 1C: Spacer plate

FIG. 1D: Petal Base plate

FIG. 1E: Spacer plate

FIG. 1F: Connector arm

FIG. 1G: Two (2) piece angle iron

FIG. 1H: Swivel

FIG. 1I: Connector rod

FIG. 1J: Pump arm

FIG. 1K: ⅜″×1½″ long Bolt

FIG. 1L: ⅜″ Lock nut

FIG. 1M: ½″×2″ long Bolt

FIG. 1N: ½″ Lock nut

FIG. 1O: ⅜″ Fine thread Lock Nut

FIG. 1P: ⅜″ Fine thread jamb nuts

### DETAILED DESCRIPTION OF THE INVENTION

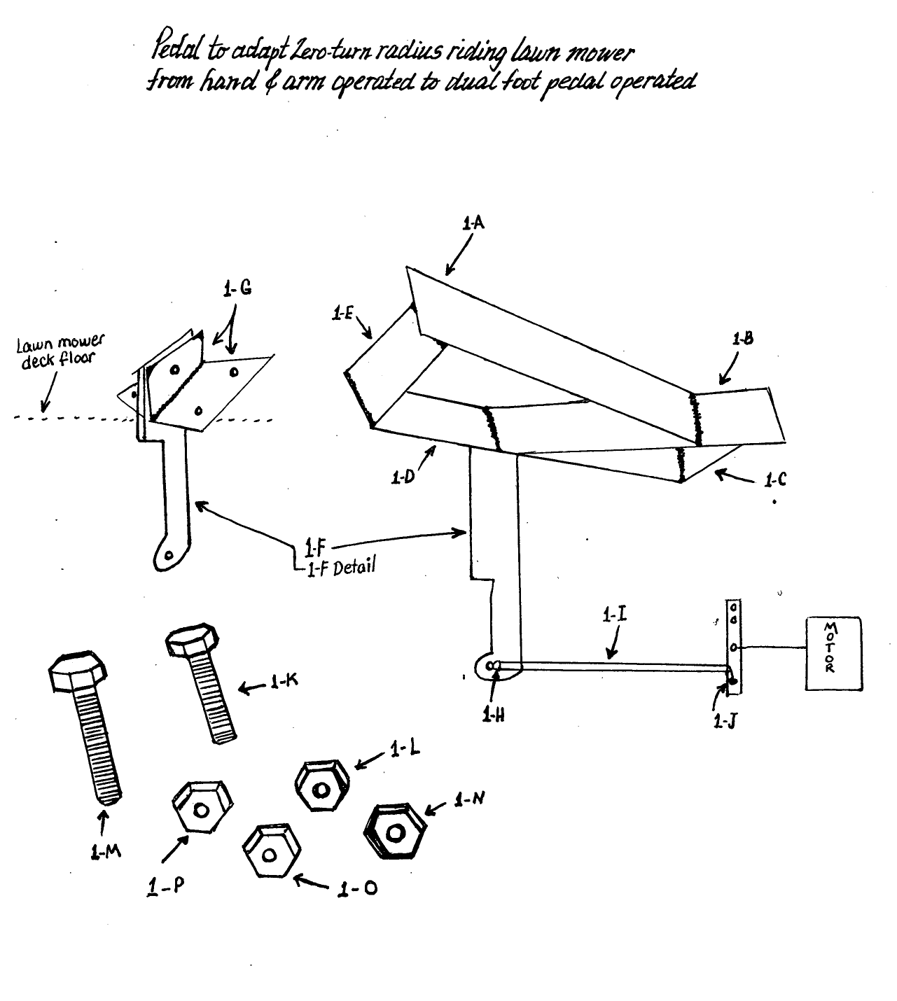

FIG. 1-A is the front of the foot pedal and measures 8½ inches long X 3¼ wide X ¼ inch thick. It is welded on one end to FIG. 1-B and to Spacer Plate FIG. 1-E. FIG. 1-B is the rear of the foot petal and measures 8½ inches long X 3¼ inches wide X ¼ inch thick. It is welded to 1-A on one end and to Spacer plate 1-C at a 45 degree angle and the other end is welded to 1-D. The other end of 1-C is welded to 1-D. 1-C is 3 inches high X 3¼ inches wide X 1/4 inch thick. 1-D is the base plate for the main pedal. 1-E is 3 inches high X 3¼ inch wide X ¼ inch thick. It is necessary to cut a ½ inch wide X 4 inch long hole in the lawn mower deck in order to insert connector arm from underneath mower deck to above deck and between both pieces of FIG. 1-G. Spacer plate 1-E is welded to 1-D and 1-A. 1-F is the Connector arm welded to the bottom center of base plate 1-D, it measure 3 inches wide X 3 inches high X ⅜ inch thick. The entire length of piece 1-F is 9 inches including the portion above and below the deck. The portion of 1-F that is below the deck is 5 inches and has a ⅜ inch hole centered in it 1 inch from the bottom. The larger portion of the piece above the deck at the top has a 1 inch hole centered 1 inch from the top. That top portion that is above the deck is 3 inches wide X 4 inches high X ⅜ inches thick. The narrower portion that is below the deck is 5 inches long X 1 inch wide X ⅜ inch thick. 1-G is the 3 inch X 2 inch X ⅜ inch thick angle iron. The 2 inch portion is bolted to the deck with two ⅜ inch holes. The rising portion is 3 inches high X 3 inches wide X ⅜ inch thick. It has one l inch hole drilled ½ inch from the top. Note that it is very important that the upper corners of the rising 3 inch angle iron must be rounded on both sides so that the pedal will rock. 1-H is the ⅜ swivel that is screwed onto the 2 inch long ⅜ inch fine thread bolt that is welded to the ½ inch rod 1-I. This swivel is mounted in the 3/8 inch hole at the bottom of 1-F. At the other end of 1-I the 2 inch long ⅜ inch fine thread bolt is welded to 1-I and one ⅜ inch swivel is screwed onto the fine threaded bolt. A ½ inch X 4 inch hole must be cut through the frame to allow the ⅜ inch swivel to be connected under neath mower frame to pump arm underneath frame of motor. The swivel is inserted 1 from the bottom into the ⅜ inch hole from the pump arm and secured by the ⅜ inch lock nut and the arm 1-J is welded to the bottom of the existing pump arm. FIG. 1-J is a Pump arm that is 5 inches long X 1 inch wide X ¼ inch thick which is welded to the bottom of the existing pump arm. The rod is 37 inches long, that is after the two fine thread bolts are welded to it. The rod length will vary on different manufactured brands of zero turn radius riding lawn mowers. The 1-P jamb nuts go behind the swivel 1-I to prevent 1-I rod from turning.

The mower is operated in its entirety by the use of both feet and does not require use of the hand or arms for operation. The only hand or arm movement required would be to release the brakes to start the mowing cycle and to apply the brakes when the mower has been powered down.

After starting the engine, the steering operation of the zero turn radius riding lawn mower is accomplished as follows:
To go straight forward, apply pressure simultaneously to the front of foot pedal FIG. 1-A using both right and left pedals.
To go straight back in reverse, apply pressure simultaneously to the rear of foot pedal FIG. 1-B using both right and left pedals.
To go forward and turn left, apply pressure with the ball of the right foot to front of right pedal FIG. 1-A and apply pressure with heel of left foot to rear of left pedal FIG. 1-B.
To go forward and turn right, apply pressure with the ball of the left foot to front of left pedal FIG. 1-A and apply pressure with heel of right foot to rear of right foot pedal FIG. 1-B.
To pivot turn to the right, apply pressure simultaneously with the ball of the left foot to the front of the left foot pedal FIG. 1-A and the heel of right foot to the rear of right pedal FIG. 1-B. This will result in a a clock-wise zero turn radius of the mower.
To pivot turn to the left, apply pressure simultaneously with the ball of the right foot to the front of the right foot pedal FIG. 1-A and the heel of the left foot to the rear of the left pedal FIG. 1-B. This will result in a counter-clockwise zero turn radius of the mower.
To increase speed, apply pressure with both feet to the front of both pedals at FIG. 1-A
To decrease speed, apply pressure with the heel of both feet to the rear of both pedals at FIG. 1-B. To come to a stop, apply pressure in a rocking motion with both feet simultaneously to the front of pedal FIG. 1-A and the rear of pedal FIG. 1-B using both left and right foot pedals.

1. The invention is a conversion of a zero turn radius riding lawn mower from a hand and arm operated model to a dual foot pedal controlled version. My mower is the only model that has been adapted for foot pedal control and it is now highly effective, efficient, and fan and effortless to operate.

2. The foot controlled conversion has numerous advantages over the arm operated model. It is easier for a physically handicapped person that suffers from severe arthritis, rheumatism, arm, hand, joint, or shoulder stiffness or for diabetics that suffer from numbness of the hands to operate their lawn mower for sustained periods of time. It is also advantageous and a time saver to the operator to be able to pick up debris with a grabber while still sitting on the machine and the machine is moving. Prior to the conversion, the operator would have had to power the machine down, get off or reach out and pick up the debris while the machine was stopped.

3. With the foot pedal version the entire body is not as tired as with the arm operated model. The foot controlled model will do everything the hand operated model will but without the constant movements that are very tedious and tiring. In some areas where there are low hanging tree limbs or branches, this model really excels in convenience and safety since the operators hands are free at all times to protect his head and body area. Staying hydrated, snacking or talking on the cell phone is especially easy while being extra safe with this hands-free conversion too! I have turned my much dreaded lawn mowing chore into a fun job with the use of my foot pedal controlled zero turn radius riding mower. It is my belief that other heavy duty zero-turn radius equipment such as Bob Cats and Loaders with hand and arm operations could also be a candidate to be converted to dual pedal foot operations.
